(19) United States
(12) Patent Application Publication
(10) Pub. No.: US 2010/0028211 A1
(43) Pub. Date: Feb. 4, 2010

(54) COVER SHEET FOR A MICROTITER PLATE

(75) Inventor: Rainer Treptow, Norderstedt (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Eppendorf AG

(21) Appl. No.: 12/278,370

(22) PCT Filed: Feb. 7, 2006
(86) PCT No.: PCT/EP06/01066

§ 371 Date: Apr. 2, 2009

(51) Int. Cl. B01L 99/00

(52) U.S. Cl. 422/99

(57) ABSTRACT

A cover sheet for a microtiter plate with weakening zones disposed in the raster of the wells of the microtiter plate.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a cover sheet for a microtiter plate.

Microtiter plates are used for the most different microbiological, cell culture and immunological operations in particular. For instance, microtiter plates are used in the PCR and in the culture of micro organisms or cells.

Microtiter plates have a plurality of deepenings for the accommodation of the sample liquid. The deepenings are also designated as wells. For instance, they are formed in a plate, or they have accommodation portions protruding from the bottom side of a plate-shaped cover wall. The cover wall may have side walls projecting towards the downside on the sides thereof. The wells have openings, which can be accessed from out the upper side of the plate. The wells are disposed on the points of a raster. The usual microtiter plates have 8×12=96 wells in rows and columns. Microtiter plates with a greater number of wells, 16×24=384 wells for instance are also being used increasingly. In most of the current commercially available microtiter plates, the raster distances of the wells correspond to the recommendations of the SBS (=Society for biomolecular screening) or the ANSI standards derived there from.

The evaporation of sample liquid out of the wells is a problem. It is essentially determined by the temperature, the air humidity and the magnitude of the surface. In many cases, evaporation leads to an unacceptable adulteration of the measurement results. This is the case in an increased degree when small volumes of the sample liquid are processed. The trend in the processing of sample liquid in the laboratory is towards more and more decreasing amounts.

In order to avoid sample loss caused by evaporation and cross contamination between the samples in different wells, it is known to press a mat against the upper side of the microtiter plate, or to seal up a sheet from silicone or PE on it. The handling of the microtiter plate with the mat being laid up is awesome, in particular when the sample liquid has to be reached several times taking off the mat from the microtiter plate. The sealing of the cover sheet onto the microtiter plate is awesome and not reversible. It is not possible to reach the sample liquid in the microtiter plate without destruction of the sealing.

GB 2 322 121 A discloses a cover for a microtiter plate, which is executed as a moulded part of greater material thickness and with a relatively complicated shape. Because of the great material thickness and the particular shape, a closure of the sample liquid like that with a stopper is achieved, i.e. with a non-positive connection on the edges of the sample container. Weakening zones are provided in order to facilitate piercing through the cover. In turn, closing the piercing opening again takes place due to the elasticity of the material, so that no complete closure is to be expected.

EP 1 302 243 A1 discloses a system for the storage of a plurality of samples, which consists of a microtiter plate and a cover sheet made from a thermoplastic polymer. In order to have access to one of the sample containers closed by the cover sheet, the cover sheet can be pierced with a needle or a pipette point or with a similar device. Through the elastic properties of the cover sheet, there is an automatic re-closure of the piercing opening, not described in more detail, after the needle- or pipette point has been removed.

However, the cover sheet is vulnerated in the region of the piercing opening, so that a hermetic closure which might prevent the evaporation of the sample is not achieved. The piercing opening can be closed only incompletely by the elasticity of the cover sheet.

Proceeding from these facts, the present invention is based on the objective to provide a cover for a microtiter plate which permits access to the sample liquid filled into the wells, but offers improved protection against evaporation of sample liquid anyway.

### BRIEF SUMMARY OF THE INVENTION

The weakening zones can be pierced by means of at least one metering tip of a pipetting apparatus or of an automatic metering machine. For instance, the metering tip is a replaceable pipette point made of plastic material or a syringe point made of metal. The weakening zones can be opened by the metering tip itself or by an arm connected to the pipetting apparatus or to the automatic machine, or by any other opening device. The metering tip which has permeated into the well can take up sample liquid or deliver it. When the metering tip is pulled out of the well and the cover sheet, the weakening zone closes itself, for instance because of an elasticity inherent to the cover sheet or because of the friction between the pipette point and an edge of the cover sheet which sits close to the same and which pulls the cover sheet back into its starting position. Through this, the sample liquid contained in the well is further protected against evaporation.

The take-up and the delivery of sample liquid takes place by means of a one channel pipetting apparatus for instance, or when there are plural wells at the same time, by means of a multi channel pipetting apparatus. Multi channel pipetting apparatuses are known by which all the wells of one row or those in all the rows and columns of microtiter plates can be processed at the same time.

According to one embodiment, the cover sheet comprises a sheet from a material with a shape memory. When the metering tip is pulled out of the weakening zone, the material with a shape memory reverts into its starting position, so that the sealing of the well is guaranteed. The use of a sheet from a material with a shape memory has the additional advantage that opening and closing the weakening zones can take place without contact. Through this, stripping off of liquid from a metering tip on the cover sheet and contamination of the cover sheet accompanied by this can be avoided. Incorporated in particular are materials with a shape memory consisting of plastic material, so called “shape memory polymers” in particular. Suitable materials are described in the contribution “Kunststoffe mit Erinnerungsvermögen” in Angewandte Chemie Vol. 114 (2002) p. 20138 to 20162 and in the U.S. Pat. No. 6,388,043 B1, the entire contents of which is incorporated herein by reference.

According to one embodiment, the cover sheet comprises a sheet from a shape memory polymer.

According to a further embodiment, the cover sheet is made of a material with a shape memory which takes a predetermined shape when energy is put in, through which a closed weakening zone opens itself according to a further embodiment, or an opened weakening zone closes itself according to another embodiment. The opened weakening zone closes itself after a time which depends on the supplied energy. For instance, the energy supply can take place by electric and/or magnetic fields and/or by light action and/or by heat action on the whole cover sheet, or concentrated to the weakening zone. A concentrated action of light and/or heat may take place by laser light for instance. The laser light can be generated by means of laser diodes at low cost, for instance. Laser light can be directed to the weakening zones from a greater distance accurately and with high energy output thereto.

According to the one embodiment mentioned above, the weakening zone opens itself due to energy input. Passing through the opened weakening zone, access to the sample in the well is possible. At a certain time after energy input, the weakening zone reverts into its initial form, so that a sample in the well is protected against loss due to evaporation.

In the other embodiment mentioned above, the weakening zone can be opened by means of the pipette point or by means of an arm or a tool or otherwise. Thereafter, an access to the sample in the well is possible through the opened weakening zone. Subsequently, the weakening zone is closed by supplying energy, so that the weakening zone reverts into its predetermined starting position in which it closes the well such that losses by evaporation are avoided.

For instance, the cover sheet is a homogeneous sheet from one single material or from a mixture of materials. According to one embodiment, the cover sheet comprises plural sheets of different materials overlaid one above the other. For instance, this permits to produce the lower side of the cover sheet from a material which is inert against sample liquid and/or which can be advantageously connected to a microtiter plate.

According to one embodiment, the cover sheet comprises sheets with different coefficients of thermal expansion. Thus, by supplying heat it is possible to provoke a bending of the cover sheet. According to the present invention, this can be used to open or to close weakening zones selectively by supplying heat thereto. Also, it is possible to close or to open the cover sheet by selective cooling at the weakening zones. When the maximum bending of two polymer sheets is too small in a short path or in the region of a weakening zone, respectively, according to one embodiment there is a metal sheet or a metal strip compounded with a sheet of a polymeric material. Depending on the heat amount supplied, the weakening zone closes itself in an adjustable time.

According to a further embodiment, the cover sheet has a sheet from a material with a shape memory and a sheet from a material with a coefficient of thermal expansion which differs from the coefficient of thermal expansion of the material having the shape memory. In this embodiment, there is a particularly strong shape change of the cover sheet when the material with shape memory is heated, because the shape change is enhanced like in a bimetal strip by the different coefficients of thermal expansion. This is advantageous in particular when shape memory polymers with faintly marked shape memory effect are used, in which heating causes in principle a shape change only across a small path.

This embodiment may be executed such that the opening or the closing of the weakening zones is controlled by energy input.

The cover sheet according to the present invention is concerned with arbitrary microtiter plates. Arbitrary external dimensions of the microtiter plates and raster distances of the wells are incorporated. The cover sheet can be provided to the user as a quasi endless material on rolls for cutting off individual sheet segments, or in the form of sheet segments with dimensions which are matched to the microtiter plate.

According to one embodiment, the raster distance of the weakening zones and/or the length and the width of the cover sheet corresponds to the raster distance of the wells of a microtiter plate and/or to the length and the width of a microtiter plate according to the recommendations of the Society of Biomolecular Screening (SBS) or the ANSI standards derived there from. It is made reference to the following ANSI standards: ANSI/SBS 1-2004: Microplates—Footprint Dimensions; ANSI/SBS 2-2004: Microplates—Height Dimensions; ANSI/SBS 3-2004: Microplates—Bottom Outside Flange Dimensions; ANSI/SBS 4-2004: Microplates—Well Positions, the entire contents of which are incorporated herein by reference. These published standards are available from the Society of Biomolecular Screening or they can be requested in the internet, respectively, namely via the following address: http://www.sbsonline.org/msdc/approved.php.

For instance, the weakening zones are regions of diminished thickness of the cover sheet. According to one embodiment, the weakening zones have at least one slit. According to one embodiment, the weakening zone has at least two slits crossing each other.

According to one embodiment, the weakening zone comprises a protuberance. The protuberance facilitates the insertion and the withdrawal of a metering tip and it can avoid strip-off effects.

According to one embodiment, the cover sheet has an adhesive coating at least on the lower side and/or consists there of polyethylene (PE) or polystyrol (PS) or another material which can be welded together with microtiter plates. This permits gluing or sealing, respectively, with the microtiter plate. But fixing the cover sheet on the microtiter plate by mechanical auxiliary means is also incorporated.

Finally, the present invention comprises a microtiter plate with a cover sheet of the kind described above.

### BRIEF DESCRIPTION OF THE SEVERAL VIEWS OF THE DRAWINGS

The present invention is explained in more detail in the following, by means of the attached drawings of examples of its realisation. In the drawings show:

FIG. 1 a microtiter plate with a sealed-up cover sheet when a pipette point approaches the same, in a vertical partial section;

FIG. 2 another microtiter plate with a sealed-up cover sheet when a pipette point approaches the same with an arm connected thereto, in a vertical partial section;

FIG. 3a to c differently realised weakening zones in a vertical section;

FIG. 4a to c differently realised weakening zones in the top view.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

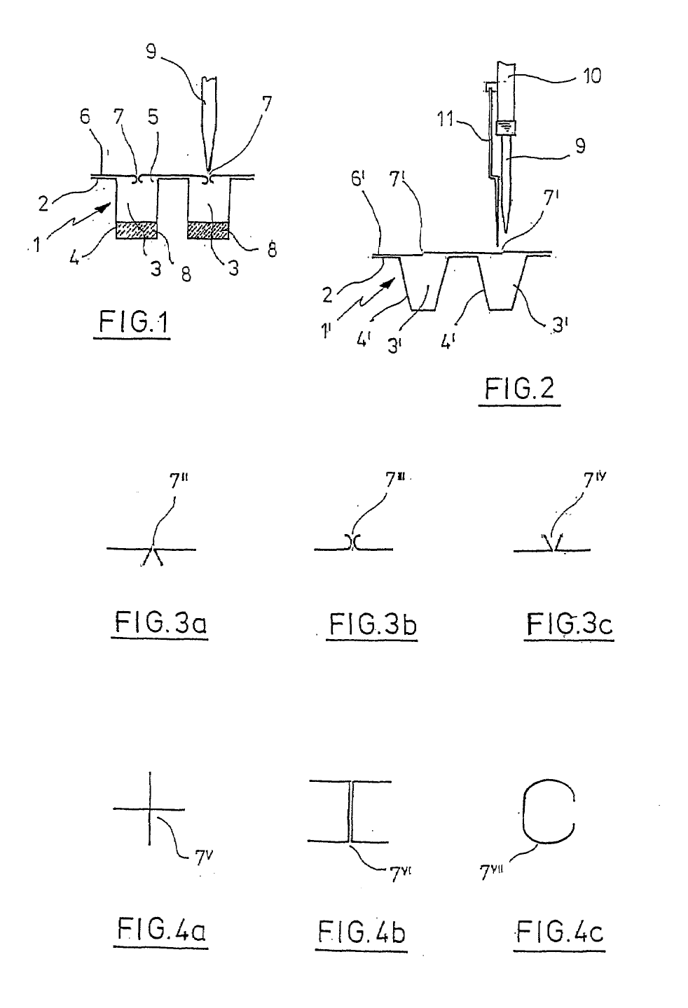

According to FIG. 1, a microtiter plate 1 has a plate-shaped covering wall 2 with a plurality of wells 3, which are delimited by accommodation portions 4 of cylindrical shape which project from the lower side of the covering wall 2. In principle, the wells 3 are accessible from out the upper side of the covering wall 2 through openings 5 in the covering wail.

A cover sheet 6 is sealed up on the upper side of the covering wall 2. The cover sheet 6 has weakening zones 7 above each well 3, which are formed by at least one slit and a protuberance of the cover sheet 6 towards the downside into the well 3. A cover sheet 6 according to the present invention has the weakening zones 7 in the raster of the wells 3 of the microtiter plate 1.

The cover sheet 6 comprises a sheet from a shape memory polymer or consists totally of such a sheet.

Before sealing the microtiter plate 1, sample liquid 8 has been filled into the wells 3. In the starting condition, the cover sheet 6 is also closed in the region of the weakening zones 7, so that sample liquid 8 cannot leak out by evaporation. The sample liquid 8 can be taken out or filled up, respectively, by means of a pipette point 9. For this purpose, the pipette point 9 can be introduced into the wells 3 via the weakening zones 7 of the cover sheet 6, which are executed as protuberances for instance.

After pulling out the pipette point 9, the cover sheet closes automatically in the region of the weakening zones 7 only partly, so that a small opening remains, through which sample liquid can evaporate. In order to close the weakening zones 7, energy is introduced into the weakening zones 7, light or heat energy for instance, in particular by means of laser light, so that the same take their initial shape again. Thereafter, the wells 3 are closed towards the upside, so that sample liquid 8 cannot leak out by evaporation.

In another embodiment, the weakening zones 7 of FIG. 1 are opened by introducing energy. Thereafter, the pipette point 9 can be inserted and withdrawn after the pipetting action without contact. The weakening zones 7 close themselves after a period of time which depends on the supplied amount of energy. This example permits to open and to close the weakening zones 7 without contact.

In the realisation example of FIG. 2, the wells 3′ and the accommodation portions 4′ of the microtiter plate 1′ are conical. The cover sheet 6′ has weakening zones 7′ in the form of simple slits.

In this example of realisation, a pipetting apparatus 10, which carries the pipette point 9 at its downside, is fixedly connected to an arm 11, which intrudes into a weakening zone 7′ in front of the pipette point 9 in order to open the same. When pulling out the pipette point 9, the arm 11 leaves the weakening zone 7′ at last. As a consequence, the arm 11 prevents a contamination of the cover sheet 6′ and of the pipette point 9, respectively, by strip-off effects. After the pipette point 9 has been pulled out, the weakening zones 7′ can be closed again by introducing energy (light and/or heat energy, for instance).

According to another embodiment, the weakening zones 7′ of FIG. 2 can be opened by introducing energy and they close themselves after a certain period of time has passed.

According to FIG. 3a, a weakening zone 7″ is realised as a slit with sheet portions in an angle towards the downside.

According to FIG. 3b, the weakening zone 7′″ is a protuberance of the cover sheet 6 towards the upside, off from the well.

According to FIG. 3c, the weakening zone 7^{IV} is a slit again, with sheet portions in an angle towards the upside.

As the weakening zones 7′″ and 7^{IV} according to FIG. 3b and FIG. 3c open themselves towards the upside, they are advantageous with very small accommodations in particular.

According to FIG. 4a, a weakening zone 7^{V} is formed by two slits crossing each other.

According to FIG. 4b, a weakening zone 7^{VI} is formed by two slit lines of a cover sheet, running U-like and touching each other on the base. Through this, two flaps are generated which can be collapsed off from the plane of the cover sheet.

According to FIG. 4c, a weakening zone 7^{VII} is formed by one single almost circularly curved slit. The same delimits a kind of flap, which can be collapsed out of the plane of the cover sheet around the axis located between the ends of the slit.

The embodiments of FIGS. 3a to 4c can be realised such that the weakening zones can be closed or opened by putting in energy.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A cover sheet for a microtiter plate (1) with weakening zones (7) disposed in the raster of the wells (3) of the microtiter plate, characterised in that it comprises a sheet (6) from a material made of plastics and having a shape memory, which takes a predetermined shape when energy is put in, wherein the weakening zones are opened or in which the weakening zones are closed.

2. A cover sheet according to claim 1, which comprises a sheet from a shape memory polymer.

3. A cover sheet according to claim 1, comprising plural sheets (6) from different materials.

4. A cover sheet according to claim 3, which comprises plural sheets (6) with different coefficients of thermal expansion.

5. A cover sheet according to claim 1, comprising a sheet (6) from a material with a shape memory and a sheet from a material with a coefficient of thermal expansion which differs from the coefficient of thermal expansion of the material having the shape memory.

6. A cover sheet according to claim 1, wherein the raster distance of the weakening zones (7) corresponds to the raster distance of the wells (3) of a microtiter plate (1) and/or the length and width of the cover sheet corresponds to the length and width of a microtiter plate (1) according to the ANSI standards.

7. A cover sheet according to claim 1, wherein the weakening zones (7) have at least one slit.

8. A cover sheet according to claim 7, wherein the weakening zone (7) has at least two slits crossing each other.

9. A cover sheet according to claim 1, wherein the weakening zone (7) comprises a protuberance.

10. A cover sheet according to claim 1, which has an adhesive coating at least on the lower side and/or consists there of polyethylene (PE) or polystyrol (PS) or another material which can be welded together with microtiter plates.

11. A microtiter plate with a cover sheet (6) according to claim 1.
